(19) United States
(12) Patent Application Publication
(10) Pub. No.: US 2016/0127255 A1
(43) Pub. Date: May 5, 2016

(54) METHOD AND SYSTEM FOR CAPACITY PLANNING OF SYSTEM RESOURCES

(71) Applicants: Diana Cobb, Redmond, WA (US); Darren Bruntz, Bellevue, WA (US)

(72) Inventors: Diana Cobb, Redmond, WA (US); Darren Bruntz, Bellevue, WA (US)

(21) Appl. No.: 14/529,035

(22) Filed: Oct. 30, 2014

(51) Int. Cl. H04L 12/911; H04L 12/26

(52) U.S. Cl. CPC H04L 47/72; H04L 43/0876

(57) ABSTRACT

In various example embodiments, a system and method for managing system resources are presented. For one embodiment, determining allocated resource budgets for a plurality of groups using system resources. A determination is made that a group from the plurality of groups is over-consuming the allocated resource budget based on a first set of rules. A determination is made that the system is operating in a busy state based on a second set of rules. A determination is made whether to enforce capping on the allocated resource budget of the group based on the over-consuming of the allocated resource budget by the group and the busy state of the system.

### TECHNICAL FIELD

Embodiments of the present disclosure relate generally to managing system resources and, more particularly, but not by way of limitation, to a method and system for capacity planning of system resources.

### BACKGROUND

The rapid increase in demand and volume for analytics has left many companies struggling to effectively manage and monitor their system resources. This is especially true for more complex organizations, where multiple groups each have existing and emerging demands for analytical resources.

### BRIEF DESCRIPTION OF THE DRAWINGS

Various ones of the appended drawings merely illustrate example embodiments of the present disclosure and cannot be considered as limiting its scope.

FIG. 1A is a high-level block diagram of a system for managing system resources, according to some example embodiments.

FIG. 1B illustrates a high-level client-server-based network architecture, according to some example embodiments.

FIG. 1C illustrates a block diagram showing components provided within the publications system of FIG. 1B, according to some example embodiments.

FIG. 1D is a block diagram illustrating a capacity planning system for a data warehouse, according to an example embodiment.

FIG. 2 is a block diagram illustrating an example embodiment of a capacity planning system, according to some example embodiments.

FIG. 3A is a flow diagram illustrating an example method for managing system resources, according to some example embodiments.

FIG. 3B is a flow diagram illustrating an example method for establishing and maintaining groups for the capacity planning system, according the some example embodiments.

FIG. 3C is a flow diagram illustrating an example method for allocating a budget for system resources to a group, according to some embodiments.

FIG. 3D is a flow diagram illustrating an example method for determining a group is over-consuming its allocated budget, according to example embodiments.

FIG. 3E is a flow diagram illustrating an example method for determining whether to enforce capping on the allocated system resources of a group, according to some embodiments.

FIG. 3F is a flow diagram illustrating an example method for enforcing capping of the system resources of a group, according to some example embodiments.

FIG. 3G is a flow diagram illustrating an example method for enforcing capping of the system resources of a group, according to other example embodiments.

FIG. 3H is a flow diagram illustrating an example method or enforcing capping based on prioritized workloads associated with the group.

FIG. 4 is a block diagram illustrating an example of a software architecture that may be installed on a machine, according to some example embodiments.

FIG. 5 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, systems and methods of managing system resources are described. The system resources may be managed by allocating system resources using a self-calibrating or auto-adjusting budget model based, in part, on past consumption, along with an active capacity management process. Managing system resources may be performed using a consumer model. The consumer may represent a business entity, having data from one or more sites or systems uploaded into a data warehouse for analytical data processing. Business entities, which have existing and emerging demands for analytical resources may effectively manage and monitor their system resources using the consumer model for resource allocation and active capacity management. The system resources may be managed by establishing resource budgets for the various groups based on past consumption by the groups, and then allocating those budgets to the various groups. In an example, a business entity may be divided into groups of people based on business units or business divisions, where each group is allocated a budget for system resources. In one example, system resources for a data warehouse used for data analytics are being allocated among the groups. When establishing the budgets, the workloads are prioritized for the group based on business needs, and any desired tradeoffs may be made. The consumption of system resources by the group is monitored with respect to the allocated resource budget for that group at a granular level, and the state of the system is monitored to determine whether to enforce capping on the group. A number of system constraints, alone or in combination, may be capped, for example, central processing unit (CPU) cycles or input/output (I/O) constraints. When enforcing capping on a group, the capping may be implemented using a tiered structure, such that users associated with a lower priority tier are capped before users associated with a higher priority tier, reserving system resources for users associated with the higher priority tiers.

In various embodiments, the capacity planning system may be used by a business entity to drive decisions for their data and analytics platform capacity, as well as guide capex (capital expenditures) based on business priorities. Furthermore, the groups may establish agreed upon budgets using the capacity planning system. The capacity planning system may provide tools to help the group leaders manage the budgets for their groups (or respective business areas). The capacity planning system may also provide tools to enable users to manage their efficiency and capacity, for example, user score cards. The capacity planning system may also provide reporting capabilities to users, such as visibility to summary and detailed infrastructure consumption and trending information. During the capacity planning process, users (e.g., group leaders) may make trade-offs with their capacity allocation.

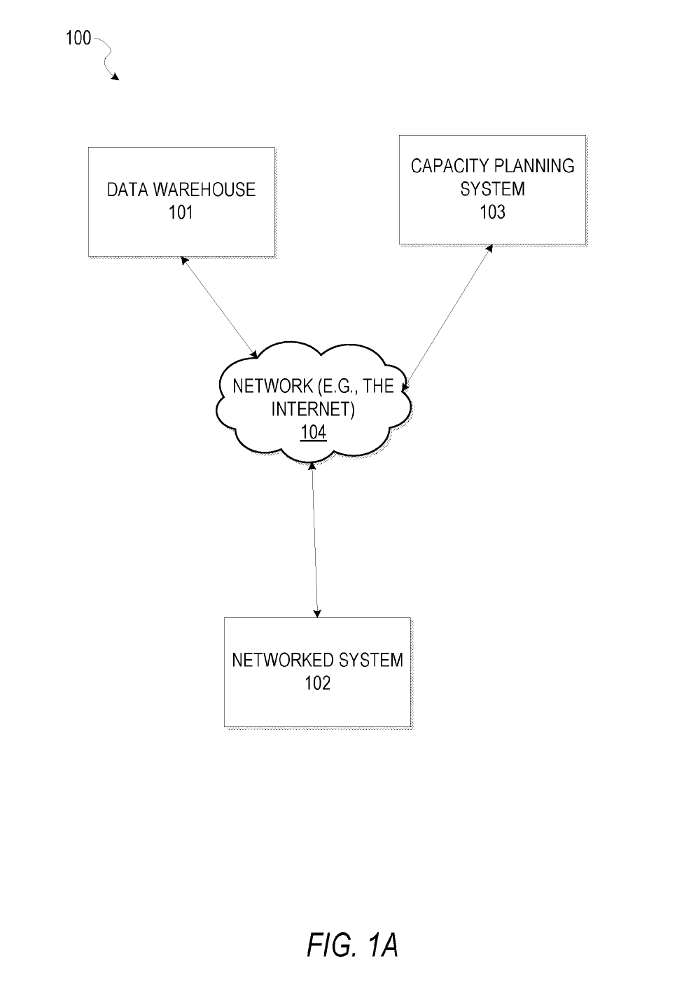

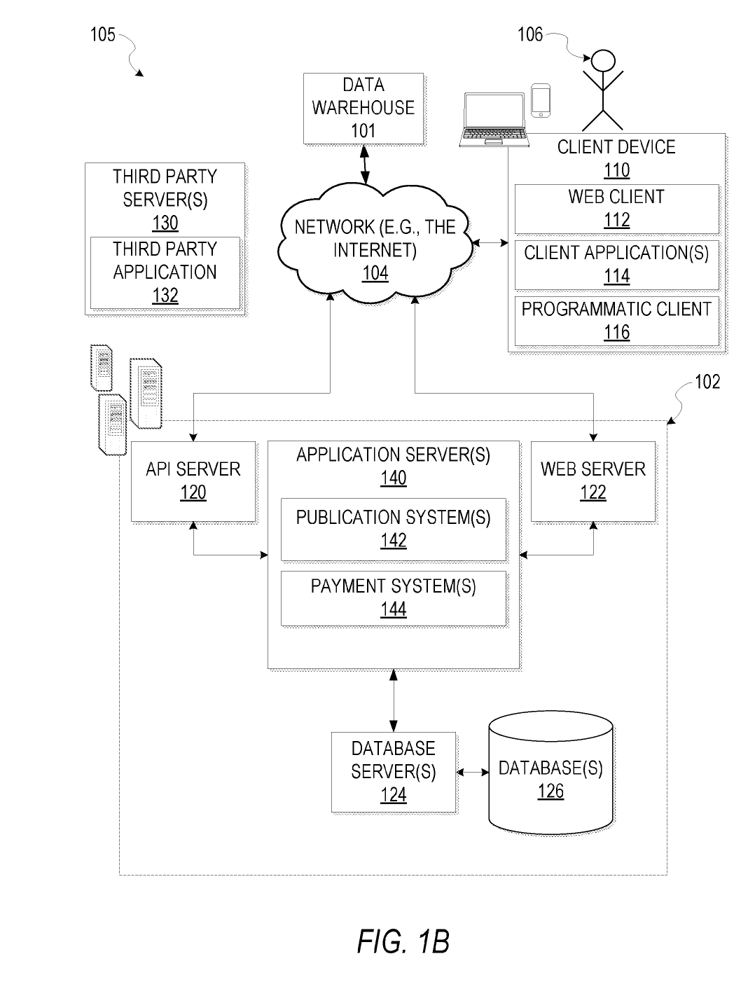

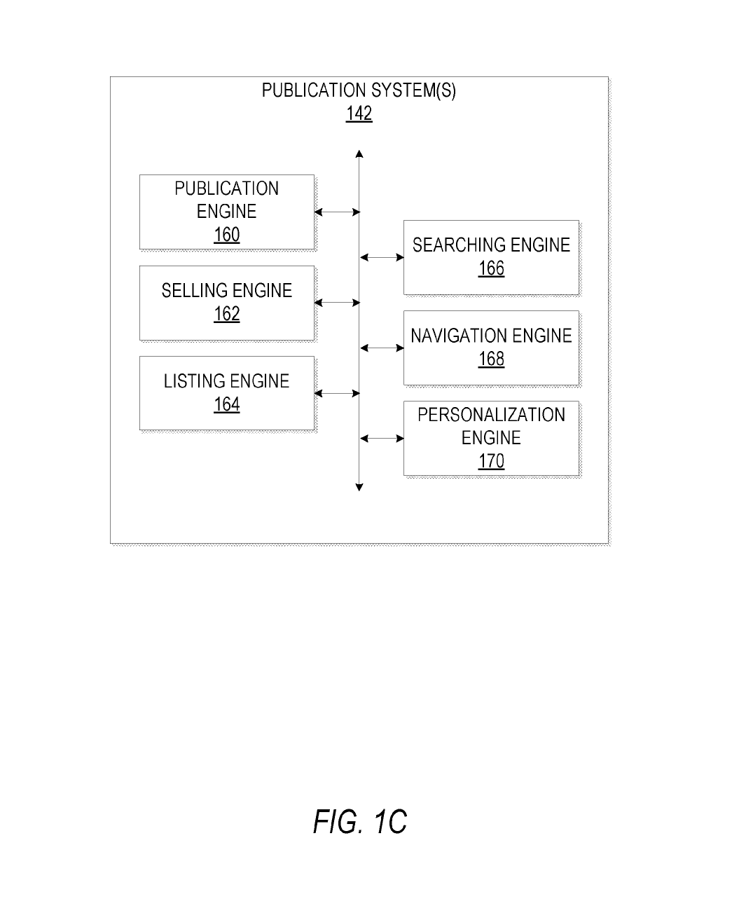

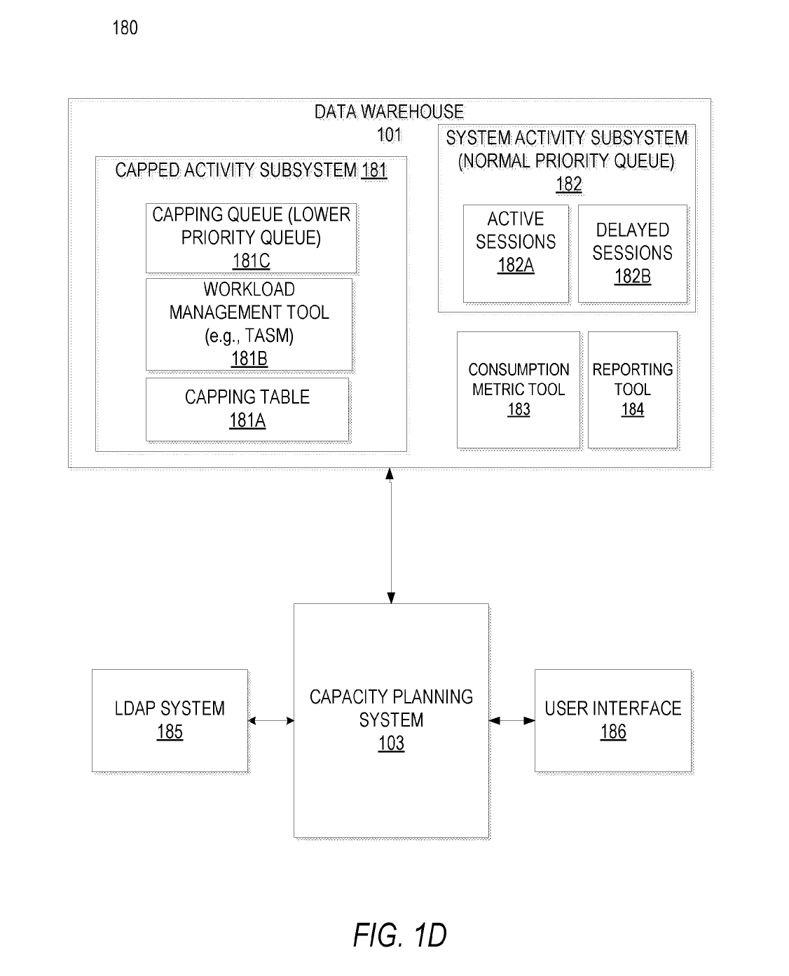

FIG. 1A illustrates a system diagram for managing system resources, according to one embodiment. The system 100 includes a data warehouse 101, a capacity planning system 103, and a networked system 102, in communication through a network 104. In example embodiments, the data warehouse 101 may represent a high concurrency, high speed analytics system, such as a Teradata system (developed by Teradata Corporation having its headquarter in Miami Township, Ohio) or a Hadoop system (developed by the Apache Software Foundation). In alternative embodiments, systems which are not used for analytics may use the capacity planning system 103, provided the system is capable of providing detailed consumption metrics for the capacity planning process.

According to FIG. 1A, the capacity planning system 103 is used to manage system resources on the data warehouse 101. The capacity planning system 103 may be implemented within the data warehouse 101, or alternatively provided as a separate system 103, as shown. The networked system 102 may be used to host one or more publication systems, payments systems, or other types of systems. For example, the publications system may include a marketplace system for an e-commerce site hosted by the network system 102. In one example, data from the marketplace system may be uploaded into the data warehouse 101 (e.g., via batch data processing). The data warehouse 101 may perform big data analytical processing on the data uploaded from the marketplace system.

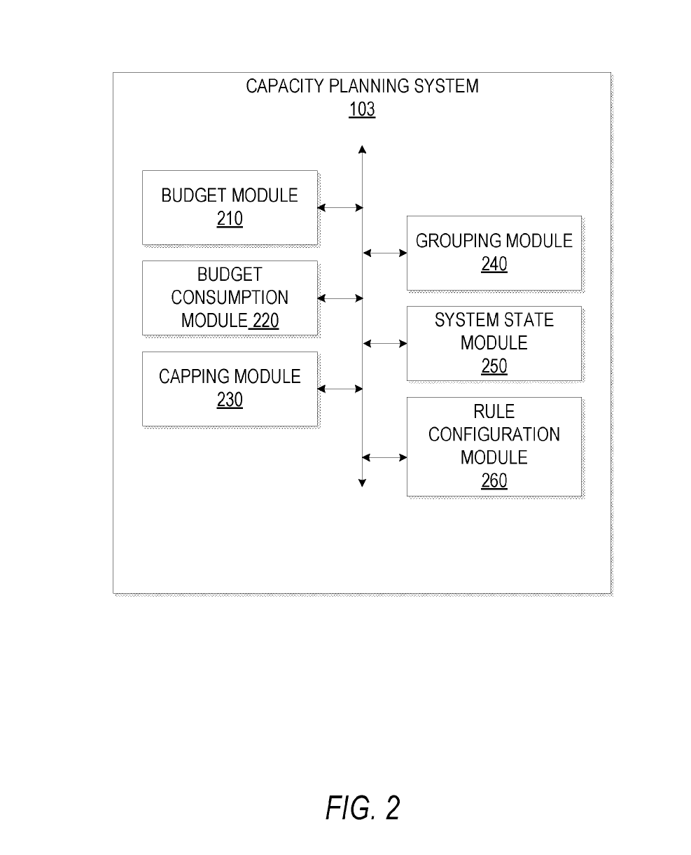

With reference to FIG. 1B, an example embodiment of a high-level client-server-based network architecture 105 is shown. The networked system 102 may represent one or more systems used to host a site, such as an e-commerce site for a business entity. The business entity may include groups within the organization that uses an analytics system (e.g., data warehouse 101) to perform data analytics on data collected, stored or generated by the networked system 102. The grouping module 240 shown in FIG. 2 describes groups in further detail below. Data from the networked system 102 may be uploaded or provided to the data warehouse 101 for data analytics performed by the users of the various groups within the business entity having allocated system resources. The system resources of the data warehouse 101 used for data analytics may be allocated and managed by the capacity planning system 103.

The networked system 102 provides server-side functionality via a network 104 (e.g., the Internet or wide area network (WAN)) to a client device 110. A user (e.g., user 106) may interact with the networked system 102 using the client device 110. FIG. 1B illustrates, for example, a web client 112 (e.g., a browser, such as the Internet Explorer) browser developed by Microsoft® Corporation of Redmond, Wash. State), client application(s) 114, and a programmatic client 116 executing on the client device 110. The client device 110 may include the web client 112, the client application(s) 114, and the programmatic client 116 alone, together, or in any suitable combination. Although FIG. 1B shows one client device 110, multiple client devices may be included in the network architecture 105.

The client device 110 may comprise a computing device that includes at least a display and communication capabilities that provide access to the networked system 102 via the network 104. The client device 110 may comprise, but is not limited to, a remote device, work station, computer, general purpose computer, Internet appliance, hand-held device, wireless device, portable device, wearable computer, cellular or mobile phone, personal digital assistant (PDA), smart phone, tablet, ultrabook, netbook, laptop, desktop, multi-processor system, microprocessor-based or programmable consumer electronic, game consoles, set-top box, network PC, mini-computer, and the like. In further example embodiments, the client device 110 may comprise one or more of a touch screen, accelerometer, gyroscope, biometric sensor, camera, microphone, global positioning system (GPS) device, and the like.

The client device 110 may communicate with the network 104 via a wired or wireless connection. For example, one or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a wireless fidelity (Wi-Fi®) network, a Worldwide Interoperability for Microwave Access (WiMax) network, another type of network, or a combination of two or more such networks.

The client device 110 may include one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps”), and so on. The client application(s) 114 may include various components operable to present information to the user 106 and communicate with networked system 102. In some embodiments, if the e-commerce site application is included in the client device 110, then this application may be configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment). Conversely, if the e-commerce site application is not included in the client device 110, the client device 110 may use its web browser to access the e-commerce site (or a variant thereof) hosted on the networked system 102.

In various example embodiments, the users (e.g., the user 106) may be a person, a machine, or other means of interacting with the client device 110. In some example embodiments, the users 106 may not be part of the network architecture 105, but may interact with the network architecture 105 via the client device 110 or another means. For instance, the users 106 may interact with client device 110 that may be operable to receive input information from (e.g., using touch screen input or alphanumeric input) and present information to (e.g., using graphical presentation on a device display) the users 106. In this instance, the users 106 may, for example, provide input information to the client device 110 that may be communicated to the networked system 102 via the network 104. The networked system 102 may, in response to the received input information, communicate information to the client device 110 via the network 104 to be presented to the users 106. In this way, the user 106 may interact with the networked system 102 using the client device 110.

An application program interface (API) server 120 and a web server 122 may be coupled to, and provide programmatic and web interfaces respectively to, one or more application server(s) 140. The application server(s) 140 may host one or more publication system(s) 142, and payment system(s) 144, each of which may comprise one or more modules or applications and each of which may be embodied as hardware, software, firmware, or any combination thereof. The application server(s) 140 are, in turn, shown to be coupled to one or more database server(s) 124 that facilitate access to one or more information storage repositories or database(s) 126. In an example embodiment, the database(s) 126 are storage devices that store information to be posted (e.g., publications or listings) to the publication system(s) 142. The database(s) 126 may also store digital goods information in accordance with some example embodiments.

Additionally, a third party application 132, executing on a third party server 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

The publication system(s) 142 may provide a number of publication functions and services to the users 106 that access the networked system 102. The payment system(s) 144 may likewise provide a number of functions to perform or facilitate payments and transactions. While the publication system(s) 142 and payment system(s) 144 are shown in FIG. 1B to both form part of the networked system 102, it will be appreciated that, in alternative embodiments, each system 142 and 144 may form part of a payment service that is separate and distinct from the networked system 102. In some example embodiments, the payment system(s) 144 may form part of the publication system(s) 142.

Further, while the client-server-based network architecture 105 shown in FIG. 1B employs a client-server architecture, the present inventive subject matter is, of course, not limited to such an architecture, and may equally well find application in a distributed, or peer-to-peer, architecture system, for example. The various systems of the applications server(s) 140 (e.g., the publication system(s) 142 and the payment system(s) 144) may also be implemented as standalone software programs, which do not necessarily have networking capabilities.

The web client 112 may access the various systems of the networked system 102 (e.g., the publication system(s) 142) via the web interface supported by the web server 122. Similarly, the programmatic client 116 and client application(s) 114 may access the various services and functions provided by the networked system 102 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

FIG. 1C illustrates a block diagram showing components provided within the publication system(s) 142, according to some embodiments. In various example embodiments, the publication system(s) 142 may comprise a market place system to provide market place functionality (e.g., facilitating the purchase of items associated with item listings on an e-commerce website). The networked system 102 may be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more database(s) 126 via the database server(s) 124.

Data generated by the publication system(s) 142, including a publication engine 160, a selling engine 162, a listing engine 164, a searching engine 166, a navigation engine 168, and a personalization engine 170 may be provided to the data warehouse 101 for analytics data processing. The system resources of the data warehouse 101 may be managed by the capacity planning system 103. In one example, the data generated by one or more of the publication engine 160, the selling engine 162, the listing engine 164, the searching engine 166, the navigation engine 168, or the personalization engine 170 may be batch uploaded at regular intervals (e.g., daily) to the data warehouse 101 for analytics data processing by one or more groups within a business entity. During the analytics data processing, workloads assigned (or allocated) to one or more groups are processed.

The networked system 102 may provide a number of publishing, listing, and price-setting mechanisms whereby a seller (also referred to as a “first user”) may list (or publish information concerning) goods or services for sale or barter, a buyer (also referred to as a “second user”) can express interest in or indicate a desire to purchase or barter such goods or services, and a transaction (such as a trade) may be completed pertaining to the goods or services. To this end, the networked system 102 may comprise a publication engine 160 and a selling engine 162. The publication engine 160 may publish information, such as item listings or product description pages, on the networked system 102. In some embodiments, the selling engine 162 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engine 162 may further comprise one or more deal engines that support merchant-generated offers for products and services.

A listing engine 164 allows sellers to conveniently author listings of items or authors to author publications. In one embodiment, the listings pertain to goods or services that a user 106 (e.g., a seller) wishes to transact via the networked system 102. In some embodiments, the listings may be an offer, deal, coupon, or discount for the good or service. Each good or service is associated with a particular category. The listing engine 164 may receive listing data such as title, description, and aspect name/value pairs. Furthermore, each listing for a good or service may be assigned an item identifier. In other embodiments, a user 106 may create a listing that is an advertisement or other form of information publication. The listing information may then be stored to one or more storage devices coupled to the networked system 102 (e.g., database(s) 126). Listings also may comprise product description pages that display a product and information (e.g., product title, specifications, and reviews) associated with the product. In some embodiments, the product description page may include an aggregation of item listings that correspond to the product described on the product description page.

The listing engine 164 also may allow buyers to conveniently author listings or requests for items desired to be purchased. In some embodiments, the listings may pertain to goods or services that a user 106 (e.g., a buyer) wishes to transact via the networked system 102. Each good or service is associated with a particular category. The listing engine 164 may receive as much or as little listing data, such as title, description, and aspect name/value pairs, that the buyer is aware of about the requested item. In some embodiments, the listing engine 164 may parse the buyer's submitted item information and may complete incomplete portions of the listing. For example, if the buyer provides a brief description of a requested item, the listing engine 164 may parse the description, extract key terms and use those terms to make a determination of the identity of the item. Using the determined item identity, the listing engine 164 may retrieve additional item details for inclusion in the buyer item request. In some embodiments, the listing engine 164 may assign an item identifier to each listing for a good or service.

In some embodiments, the listing engine 164 allows sellers to generate offers for discounts on products or services. The listing engine 164 may receive listing data, such as the product or service being offered, a price or discount for the product or service, a time period for which the offer is valid, and so forth. In some embodiments, the listing engine 164 permits sellers to generate offers from a sellers' mobile devices. The generated offers may be uploaded to the networked system 102 for storage and tracking.

Searching the networked system 102 is facilitated by a searching engine 166. For example, the searching engine 166 enables keyword queries of listings published via the networked system 102. In example embodiments, the searching engine 166 receives the keyword queries from a device of a user and conducts a review of the storage device storing the listing information. The review will enable compilation of a result set of listings that may be sorted and returned to the client device 110 of the user 106. The searching engine 166 may record the query (e.g., keywords) and any subsequent user actions and behaviors (e.g., navigations, selections, or click-throughs).

The searching engine 166 also may perform a search based on a location of the user 106. A user 106 may access the searching engine 166 via a mobile device and generate a search query. Using the search query and the user 106's location, the searching engine 166 may return relevant search results for products, services, offers, auctions, and so forth to the user 106. The searching engine 166 may identify relevant search results both in a list form and graphically on a map. Selection of a graphical indicator on the map may provide additional details regarding the selected search result. In some embodiments, the user 106 may specify, as part of the search query, a radius or distance from the user 106's current location to limit search results.

In a further example, a navigation engine 168 allows users to navigate through various categories, catalogs, or inventory data structures according to which listings may be classified within the networked system 102. For example, the navigation engine 168 allows a user 106 to successively navigate down a category tree comprising a hierarchy of categories (e.g., the category tree structure) until a particular set of listings is reached. Various other navigation applications within the navigation engine 168 may be provided to supplement the searching and browsing applications. The navigation engine 168 may record the various user actions (e.g., clicks) performed by the user 106 in order to navigate down the category tree.

In some example embodiments, a personalization engine 170 may allow the users 106 of the networked system 102 to personalize various aspects of their interactions with the networked system 102. For instance, the users 106 may define, provide, or otherwise communicate personalization settings that the personalization engine 170 may use to determine interactions with the networked system 102. In further example embodiments, the personalization engine 170 may automatically determine personalization settings and personalize interactions based on the automatically determined settings. For example, the personalization engine 170 may determine a native language of the user 106 and automatically present information in the native language.

FIG. 1D is a block diagram illustrating a system 180 for managing resources on a data warehouse 101. The capacity planning system 103 is in communication with a data warehouse 101, directly or through a network 104 (not shown). In alternative embodiments, the capacity planning system 103 may be included within the data warehouse 101. For example, the capacity planning system 103 may be running on the data warehouse 101, such as a Teradata system.

According to FIG. 1D, the data warehouse 101 includes a capped activity subsystem 181, a system activity subsystem 182, a consumption metric tool 183, and a reporting tool 184. The system activity subsystem 182 processes the normal workloads, referred to as active sessions 182A and delayed sessions 182B using the normal priority queue. The capped activity subsystem 181 processes the capped workloads or the workloads associated with capped tiers. The capping queue 181C has a lower priority queue than the normal priority queue of the system activity subsystem 182. The active sessions 182A and the delayed sessions 182B processed by the system activity subsystem 182 are processed separately from the capping queue 181C processed by the system activity subsystem 182. When a determination is made by the capacity planning system 103 to enforce capping, the capped workloads are shifted from the system activity subsystem 182 to the capped activity subsystem 181 to be processed using the capping queue 181C, which is a lower priority queue than the normal processing queue.

The capped activity subsystem 181 receives capping information from the capacity planning system 103. The capping information specifies whether a workload should be processed in the normal priority queue by the system activity subsystem or the lower priority queue by the capped activity subsystem 181. The capping information allows the capped activity subsystem 181 to determine which workloads are capped workloads to be processed by the capped activity subsystem 181 using the lower priority queue. The workloads which are not capped are processed by the system activity subsystem 182 using the normal priority queue. In some embodiments, the capping information received from the capacity planning system 103 may be used to determine whether the workloads should be processing using the normal priority queue or the lower priority queue, and workloads may be transferred between the system activity subsystem 182 and the capped activity subsystem 181 based on whether the workload requires normal priority queue processing or lower priority queue processing. For various embodiments, by moving the workloads from normal processing within the system activity subsystem 182 to the capped activity subsystem 181, and vice versa, the overall-consumption by the group may be potentially reduced. The workloads that are processed by the capped processing implemented by the capped activity subsystem 181 are generally delayed because they are placed in a lower priority queue. In various embodiments, moving the capped workload from the normal priority queue to the lower priority queue does not kill (or stop) the processing of the capped workload, but moves the workload from normal processing to capped processing. The capping information provided by the capacity planning system 103 indicates which workloads are to be moved from the normal processing queue to the lower priority queue, or from the lower priority queue to the normal processing queue. In various embodiments, the capping information is provided to the data warehouse 101, or accessed by the data warehouse 101, when a determination is made that capping is to be enforced for workloads associated with one or more groups.

During the processing of capped workloads by the capped activity subsystem 181, user IDs and batch IDs are inserted into the capping table 181A. The user ID and batch IDs may be included within the capping information to identify which workloads are to be processed by the normal priority queue or the lower priority queue. The capping information includes additional information beyond the user IDs and batch IDs. A workload management tool 181B, such a Teradata Active System Management (TASM) tool probes the capping table 181A, and identifies the capped workloads (from the capping information accessed from or provided by the capacity planning system 103) associated with the various groups in example embodiments. For one example, the profile (e.g., Teradata profile) of the capped workloads are updated, and the TASM tool identifies these profile changes and moves the workload into a different queue referred to as the capping queue 181C. For one embodiment, the capping queue 181C is processed by the capped activity subsystem 181 with limited workload processing concurrency. In other words, only a limited number of jobs or workloads may be processed at one time, therefore slowing down the processing of capped workloads or jobs.

The consumption metric tool 183 provides consumption metrics for the various groups to the capacity planning system 103. The consumption metrics may provide information on past consumption by the various groups. For example, the consumption metrics may specify metrics over various periods of time, hourly, daily, monthly, yearly, or other time periods related to past consumption by a group. The consumption metrics may also calculate past consumption on a rolling basis, for example, over the past four weeks related to past consumption by a group. In one example, the consumption metrics may indicate that a group is operating below 60% of its allocated budget from 11 μm to 9 μm, and then operating at 70% of its allocated resource budget from 9 μm to midnight, and the operating at 80% of its allocated resource budget from midnight to 3 am, and then operating at 90% of its allocated resource budget from 3 am until 1 lam. The consumption metrics may be used by the capacity planning system 103 to establish budgets for the various groups, allocate resource budgets to the various groups, determine whether the groups are over-consuming or under-consuming their allocated budgets or have reached a certain percentage of their allocated budgets. The allocated budgets may be referred to as granular and may represent an hourly budget, daily budget or some other time period. For various embodiments, the budgets are determined based on the past consumption on a rolling basis. For example, to determine a daily budget for a Monday, the capacity planning system 103 may use consumption metrics from the past four Mondays for that group. Similarly, to determine the hourly budget (e.g., 9 am) for the Monday, the capacity planning system 103 may use the consumption metrics from the same hour (e.g., 9 am) for the past four Mondays. As a result, the various budgets may be self-calibrating based on the consumption metrics from past consumption. The allocation of budgets is described below in conjunction with the budget module 210.

The reporting tool 184 provides reporting functionality to the various groups and users, for example, the group leaders. Through the reporting tool 184, the users 106 may view resource consumption information for the groups, trending information for the groups, and other information related to the resource management and active capacity planning of the data warehouse 101. In various embodiments, the users 106 may access data from the reporting tool 184 through the user interface 186.

The system 180 may also include a user interface 186 in communication with capacity planning system 103, either directly or through a network 104. The user interface 186 may be used by the various groups to provide configuration information and prioritization information for the various rules used by the capacity planning system 103.

The capacity planning system 103 is in communication with a lightweight directory access protocol (LDAP) system 185, which may be the source of hierarchical information for a business entity. The LDAP system 185 may represent an industry standard application protocol for accessing and maintaining distributed directory information services over an Internet Protocol (IP) network. For example, the LDAP system 185 may provide directory services with a hierarchical structure (or reporting structure) of user identification information (user ID). In other words, the LDAP system 185 systematically manages the hierarchy of a business entity. So as the employees of the business entity are added or removed from the various groups, the groups are updated with the current user IDs. The capacity planning system 103 receives updated user ID from the LDAP system 185. With updated user ID information from LDAP, the capacity planning system 103 is able to keep the users 106 associated with the groups consuming system resources updated. The user ID may be used to help establish budgets, allocate budgets, or determine whether a group is over-consuming its allocated budget for a certain period of time.

FIG. 2 is a block diagram illustrating components of the capacity planning system 103, according to example embodiments. The capacity planning system 103 is shown as including a budget module 210, a budget consumption module 220, a capping module 230, a grouping module 240, a system state module 250, and a rule configuration module 260. The modules 210-260 may be configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The budget module 210 provides functionality to determine the budget allocated to groups using resources of a system. For example, the system may be the data warehouse 101 used to perform analytics on data received from various systems, such as the publication systems 142 or the payment systems 144. In some embodiments, the budget module 210 evaluates budgets for the various groups based on the past consumption of the groups. The budget module 210 may evaluate the user IDs and batch IDs associated with each of the groups to determine past consumption.

The past consumption may be evaluated based on a predetermined period of time, for example the past four weeks. For an example embodiment, the budgets are updated daily by running a script. For one example, the budget module 210 may run a script daily to determine the past consumption of the various groups on a rolling basis at a daily and hourly level within the past four weeks. This information may then be used to determine the average consumption over the past four weeks at the daily and hourly level such that budgets allocated to the groups may be adjusted based on the needs of the group. The daily budget as well as the hourly budgets may be adjusted daily, by looking at the past four weeks, or some other rolling period of time. By looking at the past consumption over a rolling period of time, the budgets may self-adjust or auto-calibrate as the workloads shift for a group. In various embodiments, the budget module 210 and the budget consumption module 220, receive consumption metrics from a system (e.g., the data warehouse 101). For example, the consumption metric tool 183 (shown in FIG. 1D) may collect the consumption metrics for the various groups and provide those metrics to the capacity planning system 103 for resource management and active capacity planning.

In further embodiments, the budget module 210 provides functionality to prioritize the workloads associated with each of the groups. The past consumption of the system resources is evaluated based on the consumption metrics. The past consumption may be evaluated for a prior four week period, or some other predetermined amount of time. The past consumption may be evaluated on a rolling basis. For one embodiment, the batch identification information (batch IDs) for batch data processing are evaluated and assigned to one of the groups. The batch jobs may represent work on the system that prepares data for processing by the data warehouse 101, in particular analytics. The batch IDs may be assigned or associated with a particular group if the past consumption indicates that the particular group is the predominate user of the output from that batch workload. In other words, workloads are assigned to the groups that use the workloads the most. Furthermore, the workloads are prioritized by tiers such that resources are reserved for the highest priority workloads, as the group approaches its allocated budget, either on an hourly level, daily level, or some other time period. Any number of tiers may be used to prioritize the workloads, depending on the needs of the system. By allowing the groups to prioritize their workloads, tradeoffs may be made based on business needs. The groups prioritize their workloads by assigning the workloads into tiers. If and when a workload is capped is dependent on which tier it is assigned to.

For one embodiment, a prioritization scheme may be based on a three tier prioritization scheme with a tier 0, a tier 1, and a tier 2. In this example, all workloads associated with a group are assigned to one of the three tiers—tier 0, tier 1 or tier 2 based on how important the workload is to the group. The tier 0 may represent the core batch processes, for example the processes that everyone in the group depends on. The tier 0 may also include a few other highest priority workloads. The tier 1 may represent the next group of workloads having the highest priority below the workloads associated with tier 0. A tier 2 may represent the lowest priority workloads of the three tier scheme. The prioritization of the workloads, based on tiers, may be used by the capping module 230 for capping workloads. For one example, if a group has reached 80% of its allocated budget (e.g., hourly budget), tier 2 is capped such that the remaining allocated budget is reserved for both tier 1 and tier 0. For another example, as the group approaches 100% of its allocated budget (e.g., daily budget), both tier 2 and tier 1 are capped, and any available resources may be reserved for tier 0. For purposes of capping, the hourly budget (checked at specific intervals), the daily budget, and/or another budget for a specific time period, or a combination of budgets may be used.

The budget consumption module 220 provides functionality to determine whether a group is over-consuming or under-consuming based on a set of rules. This set of rules may be referred to as the first set of rules or the budget consumption rules. The budget for system resources is divided among various groups. The budget consumption module 220 receives grouping information from the grouping module 240.

In one embodiment, the first set of rules is based on a daily budget of the group. In alternative embodiments, a budget for allocated resources may be based on a time period other than a daily budget. In a further embodiment, the first set of rules is based on determining the hourly consumption of the group has been exceeded by a first percentage of the hourly budget, and determining the daily consumption of the group has been exceeded by a second percentage of the daily budget. In one example, the first percentage may be 80%, and the second percentage may be 100%. Other percentages for the first percentage and the second percentage may be used in other embodiments. In another embodiment, the hourly budget is determined by an average consumption by the group over a rolling period of time hourly, and the daily budget is determined by an average consumption by the group over a rolling period of time daily. The hourly and daily budgets are then used to determine whether the group is over-consuming or under-consuming their allocated resource budgets. In various embodiments, the first set of rules is implemented by the budget consumption module 220.

The capping module 230 provides functionality to determine whether to cap workloads or processes associated with one or more tiers. Each tier represents a group of workloads or processes prioritized within a group. For various embodiments, the capping module 230 caps a particular group based on a set of rules. The rules may be referred to as a third set of rules or capping rules. When workloads associated with a tier are being capped, the workloads may be shifted from the system activity subsystem 182 (shown in FIG. 1D) to the capping queue 181C (shown in FIG. 1D), within the capped activity subsystem 181. The workloads which are not capped are processed by the system activity subsystem 182 (shown in FIG. 1D) using the normal priority queue. For various embodiments, by moving the workloads from normal priority queue to lower priority queue, the overall-consumption by the group may potentially be reduced. The workloads that are processed through the capping process are generally processed slower due to delays from being placed in a lower priority queue. In various embodiments, capping a workload does not kill (or stop) the processing of the workload, but moves the workload from normal workload processing in the normal priority queue to capped workload processing in the lower priority queue. In further embodiments, a workload may be moved from the lower priority queue to the normal priority queue.

For one embodiment, workloads associated with capped tiers are referred to as capped workloads. The workloads associated with the various groups, including associated user IDs and batch IDs, are inserted into the capping table 181A. A workload management tool 181B, such a Teradata Active System Management (TASM) tool probes the capping table 181A, and identifies the capped workloads associated with the various groups. For one example, the profile (e.g., Teradata profile) of the capped workloads are updated, and the TASM tool identifies these profile changes and moves the workload into a different queue referred to as a capping queue 181C (shown in FIG. 1D) for capped workload processing. For one embodiment, the capping queue 181C is processed by the capped activity subsystem 181 (shown in FIG. 1D) with limited concurrency. In other words, only a limited number of jobs or workloads may be processed at one time, and therefore slowing down the processing of capped workloads or jobs.

For one example, if a group has reached 80% of its allocated budget (e.g., hourly budget), tier 2 is capped such that the remaining allocated budget is reserved for both tier 1 and tier 0. For another example, if the group has reached 100% of its allocated budget (e.g., daily budget), both tier 2 and tier 1 is capped. For purposes of capping, the hourly budget (as specific intervals), the daily budget, or another budget for a specific time period, or a combination of budgets may be used to implement a tiered capping process.

In one embodiment, the third set of rules is based on the following criteria: (1) evaluating an hourly budget at two hour increments to determine if the group has reached a first percentage of the allocated resource budget; (2) evaluating a daily budget to determine whether the group is under-consuming or over-consuming on the daily budget based on a second percentage of the allocated resource budget; and (3) delaying the workloads from at least one of the lowest priority tiers of multiple tiers used to prioritize workloads. In further embodiments, the third set of rules is based on (1) determining whether the group has reached a first percentage of a granular budget; and (2) capping the lowest priority workloads associated with a lowest priority tier. The granular budget may represent a daily budget, an hourly budget, or some other budget based on a defined time period. In other embodiments, the third set of rules is based on (1) determining whether the group has reached a first percentage of an hourly budget; (2) capping the lowest priority workloads associated with a lowest priority tier; and (3) determining whether the groups has reached a second percentage of the daily budget; and (4) capping at least two of the lowest priority workloads associated with the two lowest priority tiers. In various embodiments, the third set of rules is based on a plurality of tiers for prioritizing the workload associated with a group.

The grouping module 240 provides functionality for grouping the consumers of system resources. In example embodiments, the user IDs and batch IDs are assigned to the various groups. The user IDs allow the system to manage the consumption by users 106 within each group, and the batch IDs allow the system to manage batch data processing, which acquires data from a system or site (e.g., a marketplace system), and then loads the data into the data warehouse 101 for processing, such as analytical processing. Batch IDs may be assigned to the group based on the user IDs associated with those users 106 consuming the data from the batch data processing. The batch IDs may be assigned or associated with a particular group if the past consumption indicates that the particular group is the predominate user of the output from that batch workload. In other words, workloads are assigned to the groups that use the workloads the most. For example, if the consumer is a business entity, the groups may be established based on the organizational structure of the business entity. In one example, the business entity may include a hierarchical reporting structure, where the level 1 leader represents the head of the business entity. Direct reports to the leader of level 1 may be referred to as level 2 leaders, and employees who report up to the level 2 leader (either directly or indirectly) may be included in the level 2 grouping who they report up to. In further examples, the level 2 groups that do not consume as much resources as other level 2 groups may be consolidated or aggregated into a single group for purposes of resource allocation. A business entity may decide to divide groups based on the level 2 organizational hierarchy (or other levels within an organization hierarchy) for purposes of reporting or accountability to the level 2 leaders within the business entity. For example, resources allocated to each level 2 group leader may be charged back to the level 2 group leader as part of the business entities accounting practices. In other examples, the groups may be based on domains, initiatives or other criteria of the consumer of the system resources. The allocation of the system resources for budget purposes may not be allocated equally among the various groups.

In various embodiments, the grouping module 240 provides functionality to maintain or update the groups consuming the system resources. For example, the group may be kept current based on changes in the organization structure of a business entity. In one embodiment, a company's lightweight directory access protocol (LDAP) system 185 (shown in FIG. 1D) may be the source of hierarchical information for the business entity. The LDAP system 185 may represent an industry standard application protocol for accessing and maintaining distributed directory information services over an Internet Protocol (IP) network. For example, the LDAP system 185 may provide directory services with a hierarchical structure (or reporting structure) of user identification information (user ID). In other words, the LDAP system 185 systematically manages the hierarchy of a business entity. As employees of the business entity are added or removed from the various groups, the groups are updated with the current user IDs in the LDAP system 185. The LDAP system 185 may provide this information to the capacity planning system 103 to keep the capacity planning system 103 updated with current group information.

In one embodiment, the grouping module 240 is configured to determine the group based upon an organizational structure of a business entity. In some embodiments, the grouping module 240 is configured to automatically update a plurality of users 106 associated with the group based on changes in the organization structure. In other embodiments, the grouping module 240 is further configured to divide (or allocate) batch ids for batch data processing on the system to the various groups in the plurality of groups. In further embodiments, the grouping module 240 is further configured to prioritize the batch ids into one of a plurality of tiers having different priority levels. By assigning workloads and users 106 to groups, and then prioritizing the workloads based on the business needs, the group leaders may make tradeoffs when managing their system resources.

The system state module 250 provides functionality to determine whether the system (e.g., data warehouse 101) is operating in a busy state. In various embodiments, both the consumption by the group and the state of the system are used to determine whether to enforce capping. The state of the system is determined based on a set of rules. These rules may be referred to as a second set of rules or the state rules. The state of the system may be determined based on the number of active sessions 182A (shown in FIG. 1D) being processed by the system activity subsystem 182 along with the number of delayed sessions 182B (shown in FIG. 1D). In other embodiments, the second set of rules may be based on other criteria.

In one embodiment, the second set of rules is based on determining the system is operating at the designated busy state. In a further embodiment, the determination that the system is operating in a busy state is based on exceeding a threshold value, where the threshold value represents the number of active system sessions or delayed system sessions in a system queue, such as the system activity subsystem 182. One example of a threshold value is 70 sessions (including active sessions 182A being processed and delayed sessions in the delay queue 182B). The threshold value may be a user specified value.

In operation, the system is often busy during the prime hours. For example, the prime hours for the system may be between the hours of 3 am until 10 am daily. The prime hours are typically when there are the most sessions running (or in the delay queue 182B). For example, daily batch data processing may be performed in the evening from midnight until 3 am, when data is batch uploaded into the system (e.g., data warehouse 101, shown in FIGS. 1A and 1C). Once the data is available in the system, the various groups start processing the data and consuming system resources.

The rule configuration module 260 provides functionality to allow group leaders or groups to define their own rules by setting various parameters for one or more of the first rule set, the second rule set or the third rule set. For example, the group leader may define the percentages used in the capping process. In one embodiment, the rule configuration module 260 is configured to configure one or more parameters from the first set of rules, the second set of rules or the third set of rules. In some embodiments, the rule configuration module 260 provides the group leaders (e.g., level 2 group leader) configuration of one or more of the rules or parameters based on the group's needs. In other words, self-service functionality may be provided or offloaded to the various groups to help them better manage their allocated system resources.

The capacity planning system 103 may be used to manage system resources for various groups. According to one embodiment, the budget module 210 is configured to determine budgets for allocating resources for a plurality of groups using system resources. The budget consumption module 220 is configured to determine if a group from the plurality of groups is over-consuming the allocated resource budget based on a first set of rules. The system state module 250 is configured to determine if the system is operating in a busy state based on a second set of rules. The capping module 230 is configured to determine whether to enforce capping on the allocated resources of the group based on the over-consuming of the allocated resource budget by the group and the busy state of the system. In further embodiments, the capping module 230 is configured to enforce capping on the allocated resource budget based on a third set of rules associated with prioritized workloads for the group.

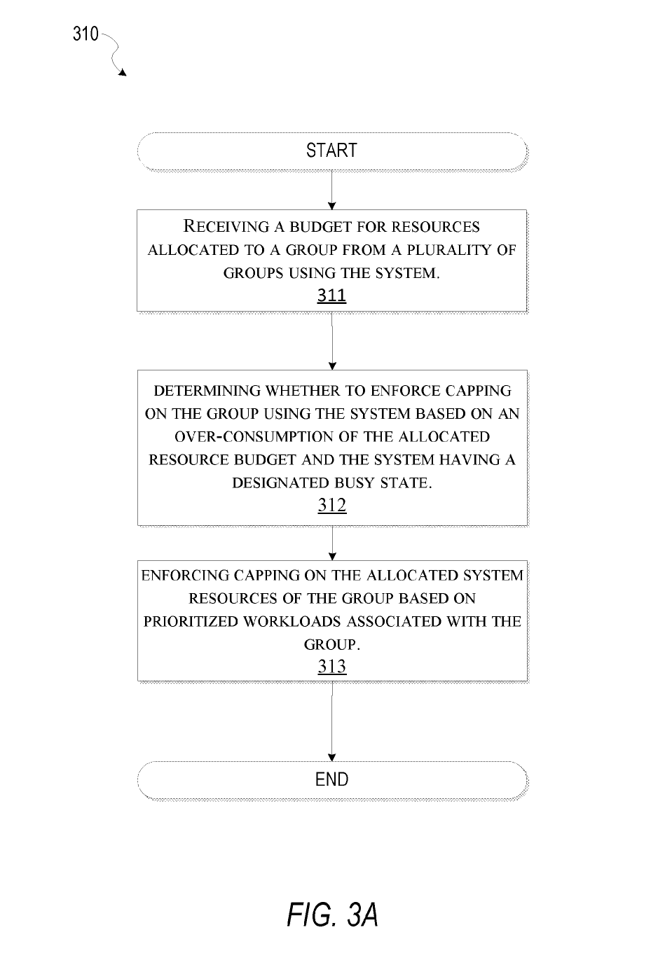

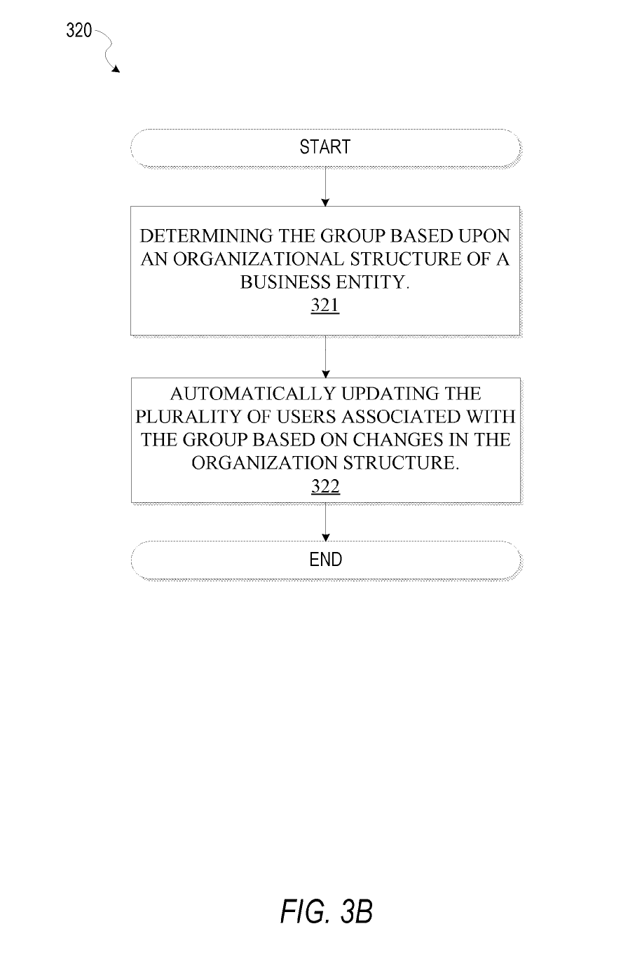

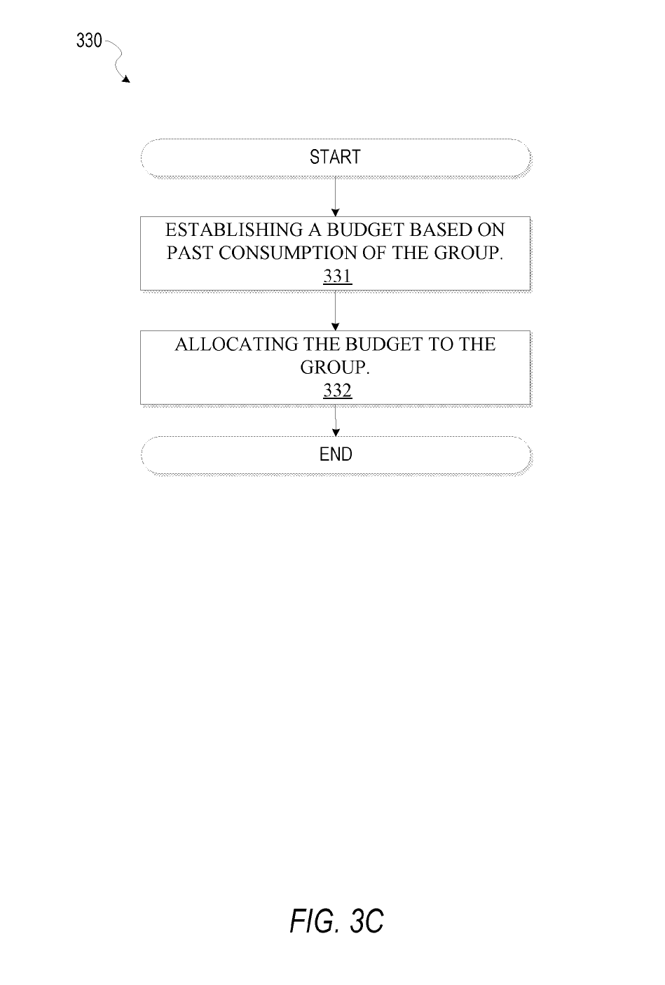

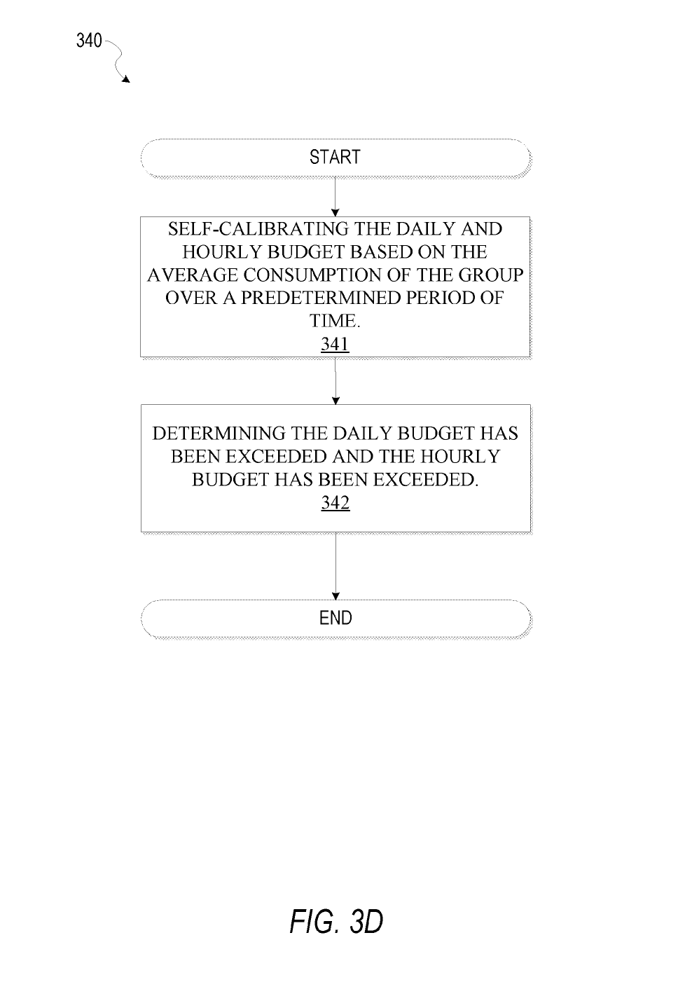

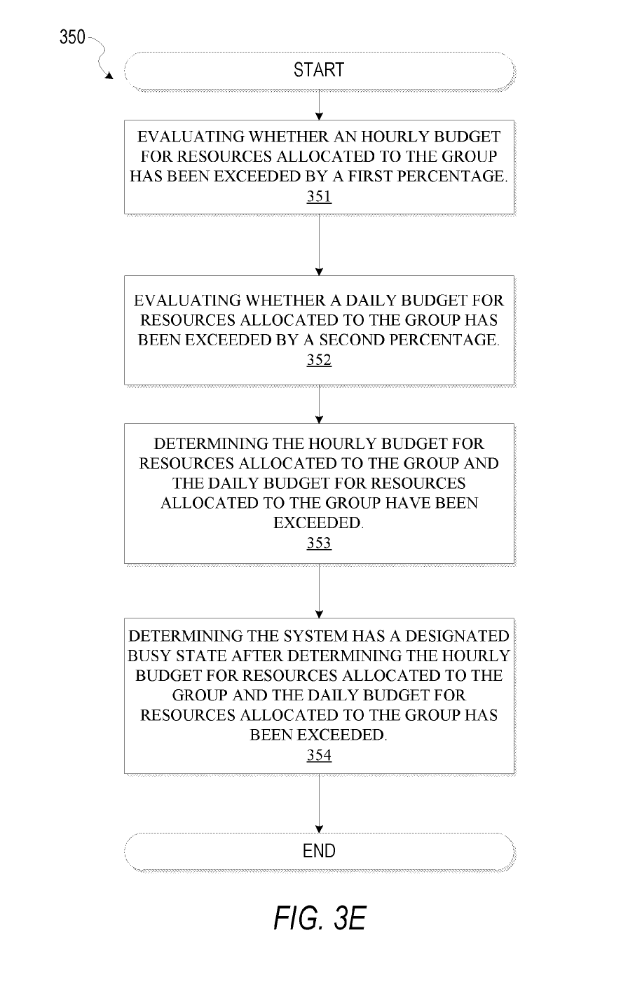

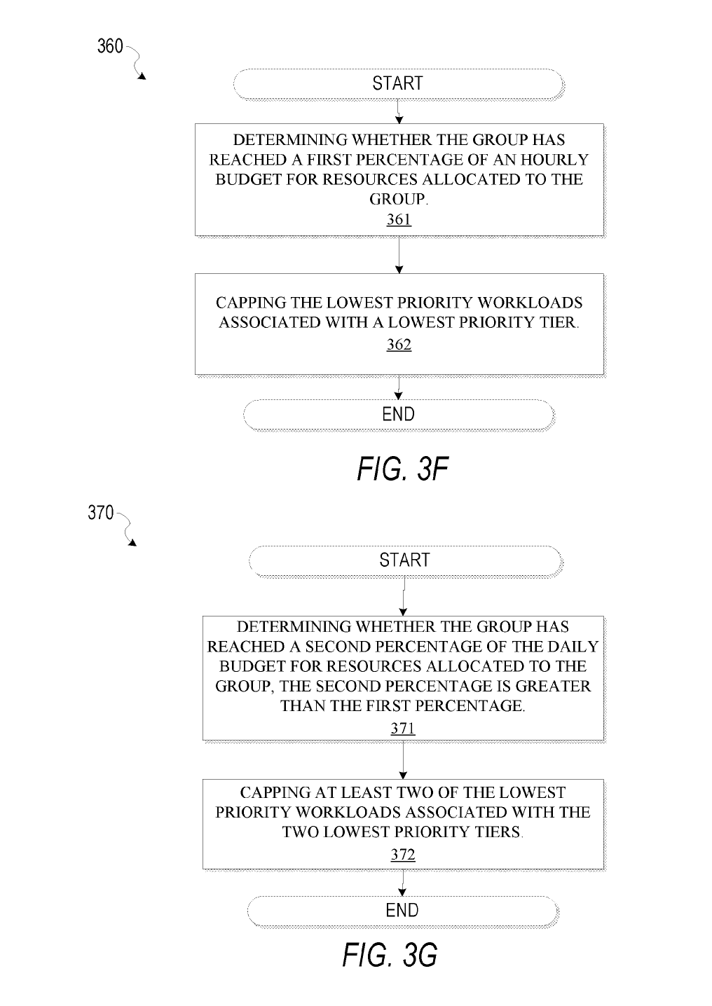

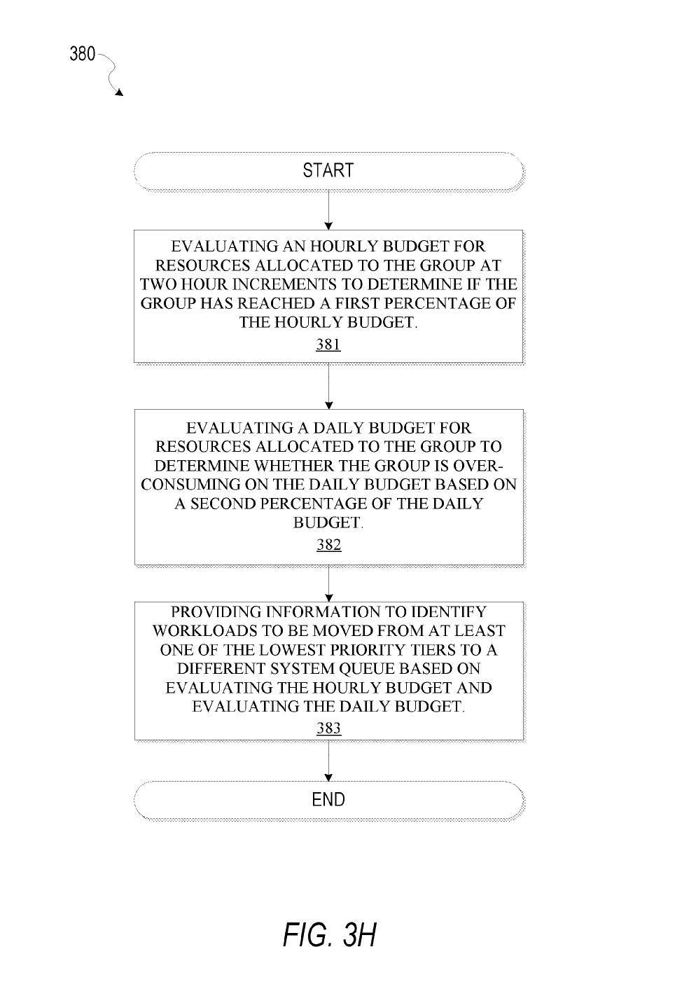

FIG. 3A is a flow diagram illustrating an example method 310 for managing system resources. The method 310 shown in the flow chart includes operations 311-313. At operation 311, a budget is received for resources allocated to a group from a plurality of groups using the system. At operation 312, a determination is made whether to enforce capping on the group using the system based on an over-consumption of the allocated resource budget and the system having a designated busy state. In one example, over-consumption of the allocated resource budget occurs when an hourly budget for resources allocated to the group has been exceeded by a certain percentage (e.g., 80%). In another example, over-consumption of the allocated resource budget occurs when a daily budget for resources allocated to the group have been exceeded by a certain percentage (e.g., 90%). The hourly and/or daily budget may represent an average of the past consumption by the group over a four week period. In another example, the system may be designated to have a busy state if a threshold value representing a number of session (both active sessions 182A and delayed sessions 182B) in the normal priority queue has been exceeded. At operation 313 capping is enforced on the resources allocated to the group based on prioritized workloads associated with the group.

FIG. 3B is a flow diagram 320 illustrating an example method 310 of managing system resources by assigning resources to several groups, where each group is associated with a plurality of users 106 from an organizational structure. At operation 321, a group is determined based upon an organizational structure of a business entity. At operation 322, the plurality of users 106 associated with the group is automatically updated based on changes in the organizational structure. For an example embodiment, the organization structure may include a hierarchical organization tree with level 1 being the top level, level 2 being the next lower level, level 3 being one level lower than level two, and so forth. In one example, the groups may be determined based on the level 2 within an organizational structure of a company. In some examples, more than one level 2 group may be consolidated to create a single group for resource allocation. An entity may select level 2 within its organization structure because the leader of level 2 within the entity is accountable for various items at that level. In some examples, the budget for resources allocated to that group may be charged back to the leader of level 2. In alternative embodiments, groups may be organized by domains, initiatives, or various other groupings suitable for the entity. As the groups are automatically updated, the allocated budgets for the groups may be self-calibrate or auto-adjust.

FIG. 3C is a flow diagram illustrating an example method 330 for receiving an allocated resource budget. At operation 331, a budget based on past consumption of the group is established. At operation 332, the budget is allocated to the group. In one example, the budget is allocated to the group by allocating a batch ID for batch data processing to the group based on the past consumption of the group associated with the batch ID. In another example, the batch ID is allocated by prioritizing the batch ID into one of a plurality of tiers having different priority levels. In further examples, the operation 332 of receiving the allocated budget for the group includes receiving the allocated resource budget based on one or more parameters constraining the system. In another example, the operation 311 of receiving the allocated budget for the group includes receiving the allocated resource budget based on CPU cycles. In a further example, the operation 311 of receiving the allocated budget for the group includes receiving the allocated resource budget based on input/output (I/O) constraints or other system constraints.

FIG. 3D is a flow diagram illustrating an example method 340 for determining the over-consumption of the budget for resources allocated to the group. At operation 341, self-calibrating the daily budget for resources allocated to the group and hourly budget for resources allocated to the group based on the average consumption of the group, over a predetermined period of time. At operation 342, determining the daily budget group for resources allocated to the group has been exceeded, and the hourly budget for resources allocated to the group has been exceeded.

In one example, the operation 341 may self-calibrate the daily budget for resources allocated to the group daily. The daily budget may be evaluated at a daily level as well as an hourly level. In various examples, self-calibrating the budget may include determining the budget for resources allocated to the group based on an average consumption by the group over a rolling period of time at an hourly level. In other examples, self-calibrating the budget may include determining the budget for resources allocated to the group based on an average consumption by the group over a rolling period of time at a daily level. For example, if today is Friday and the system is self-calibrating the daily budget for a group, then it may look at the daily consumption of the group over the last four Fridays and determine the average consumption over the past four weeks. Furthermore, the system may self-calibrate the daily budget at an hourly level. If it is 3 am on Friday, the system may look at the hourly consumption of the group over the last four Fridays at 3 am to determine the average hourly consumption at that specific hour (e.g., 3 am).

In one example, the operation 342 includes determining the hourly consumption of the group has been exceeded by a first percentage of the hourly budget for resources allocated to the group; and determining the daily consumption of the group has been exceeded by a second percentage of the daily budget for resources allocated to the group. For example, the first percentage may be 80% of the hourly budget and the second percentage may be 100% of the daily budget. In other words, if the group has exceeded 80% of its hourly budget for allocated resources at 10 am on a Monday, then the system checks if the group has exceeded 100% of its daily budget for allocated resources on Monday. In further examples, the operation 342 may include determining over-consumption of the budget at the hourly level by comparing the budget at the hourly level with the current hourly consumption of the group. In other examples, the operation 342 may determine over-consumption of the budget at the daily level by comparing the budget at the daily level with a current daily consumption of the group.

FIG. 3E is a flow diagram illustrating an example method 350 for determining to enforce capping. The method 350 includes operations 351-354. At operation 351, evaluating whether an hourly budget for resources allocated to the group has been exceeded by a first percentage. At operation 352, evaluating whether a daily budget for resources allocated to the group has been exceeded by a second percentage. At operation 353, determining the hourly budget for resources allocated to the group and the daily budget for resources allocated to the group have been exceeded. At operation 354, determining the system has a designated busy state after determining the hourly budget for resources allocated to the group and the daily budget for resources allocated to the group has been exceeded. In one example, a determination is made that the system is operating at the designated busy state based on exceeding a threshold value, where the threshold value represents the number of active system sessions or delayed system sessions in a system queue. For example, the threshold value may be 70 sessions (either active or delayed).

FIG. 3F is a flow diagram illustrating an example method 360 for enforcing capping based on prioritized workloads associated with the group according to an example embodiment. The method 360 includes operations 361-362. At operation 361, determining whether the group has reached a first percentage of an hourly budget for resources allocated to the group. At operation 362, capping the lowest priority workloads associated with a lowest priority tier. For one example, the hourly consumption of the group is checked at two hour intervals or two hour increments.

FIG. 3G is a flow diagram illustrating an example method 370 for enforcing capping based on prioritized workloads associated with the group, according to another example embodiment. The method 370 includes operations 371-372. At operation 371, determining whether the group has reached a second percentage of the daily budget for resources allocated to the group. At operation 372, capping at least two of the lowest priority workloads associated with the two lowest priority tiers.

Methods 360 and 370 may be combined to provide flexibility when enforcing capping for a group. For example, an allocated resource budget for a group is 100 CPU cycles. The group is offsite in the morning and the system is offline. However, the group jumps back onto the system late on that day, and needs to get caught up on the work for that day. The hourly budget may exceed the first percentage (e.g., 80%) for a particular hour (e.g. 6 pm). However, the daily budget may not be exceed the second percentage (e.g., 75%) since no one was working on the system in the morning. In this scenario, the capping process is forgiving with the shift in daily workload and does not enforce capping because the group was under-consuming with respect to their daily budget, even if the hourly budget was over-consumed.

FIG. 3H is a flow diagram illustrating an example method 380 for enforcing capping based on prioritized workloads associated with the group. The method 380 includes operations 381-383. At operation 381, evaluating an hourly budget for resources allocated to the group at two hour increments to determine if the group has reached a first percentage of the hourly budget. At operation 382, evaluating a daily budget for resources allocated to the group to determine whether the group is under-consuming or over-consuming on the daily budget based on a second percentage of the daily budget. At operation 383, providing information to identify workloads to be moved from at least one of the lowest priority tiers to a different system queue based on evaluating the hourly budget and evaluating the daily budget. In various examples, the operation 383 caps the workloads from one or more of the lower tiers based on the percentage of the budget reached (e.g., hour budget or daily budget) delays (or provides information to delay) the processing of the workloads that were moved to the different system queue. In another example, information is provided to delay processing of capped workloads, where the capped workloads represent lower priority workloads based on the prioritized workloads associated with the group.

For one example, the processing of the workloads from the capped tiers are moved to a Teradata Active Management System (TASM) which provides various workload management functions in a Teradata System (provided by Teradata Corp in Dayton Ohio). Workloads associated with capped tiers are then processed using a capping process. For one example, the workloads associated with the capped tiers are inserted into a table in TASM. These workloads associated with capped tiers from a group include the batch ids and user ids. The capping process implemented by TASM changes the workload profile in the Teradata system and places these workloads into a special queue (which is a queue different from workloads from non-capped tiers). In some examples, the capping process slows down the job of the workloads associated with capped tiers by processing these workloads in a system with limited concurrency such that only a few jobs can run at the same time.

In various examples, multiple tiers are configured based on the needs of the site that is providing data to the data warehouse 101 for performing big data analytics. Tier 0 may be defined as being associated with the highest priority workloads. Tier 0 may include the core batch processes that everyone depends on, as well as a few other high priority workloads. Tier 1 may include the next highest priority workloads (that are prioritized lower than the tier 0 workloads). In a 3 tier system, Tier 2 may include the lowest priority workloads. The workloads associated with each of the tiers, based on prioritizations, may be determined automatically by the system, manually by various users 106 (e.g., system administrators or level 2 leaders), or partially automated and partially manual. In one example, if the group's consumption reaches 80% of its allocated resource budget, then tier 2 may be capped for the group. In another example, if the group's consumption reaches 100% of its allocated resource budget, than both tier 1 and tier 2 may be capped. This capping process allows the tier 0 workloads to have priority when operating near or at the groups allocated resource budget. For various examples, the workloads associated with capped tiers are moved to a different processing queue from the non-capped tiers. The capped tiers are then processed with a much lower priority and consumption potential on the system without killing the workloads that are running. In some examples, by enforcing capping on one or more tiers, many workloads are pushed later into the day, when resources are free or available.

In further embodiments, a method of enforcing capping on prioritized workloads associated with a group includes receiving input from a user 106 to adjust the first percentage or the second percentage. In one example, the user 106 may represent the group's leader (e.g. level 2 leader for an organization structure of an entity). A user interface 186 may be provided on a computing device to the various groups to allow them to configure one or more parameters of the capping system.

### Modules, Components, and Logic

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application specific integrated circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Software Architecture

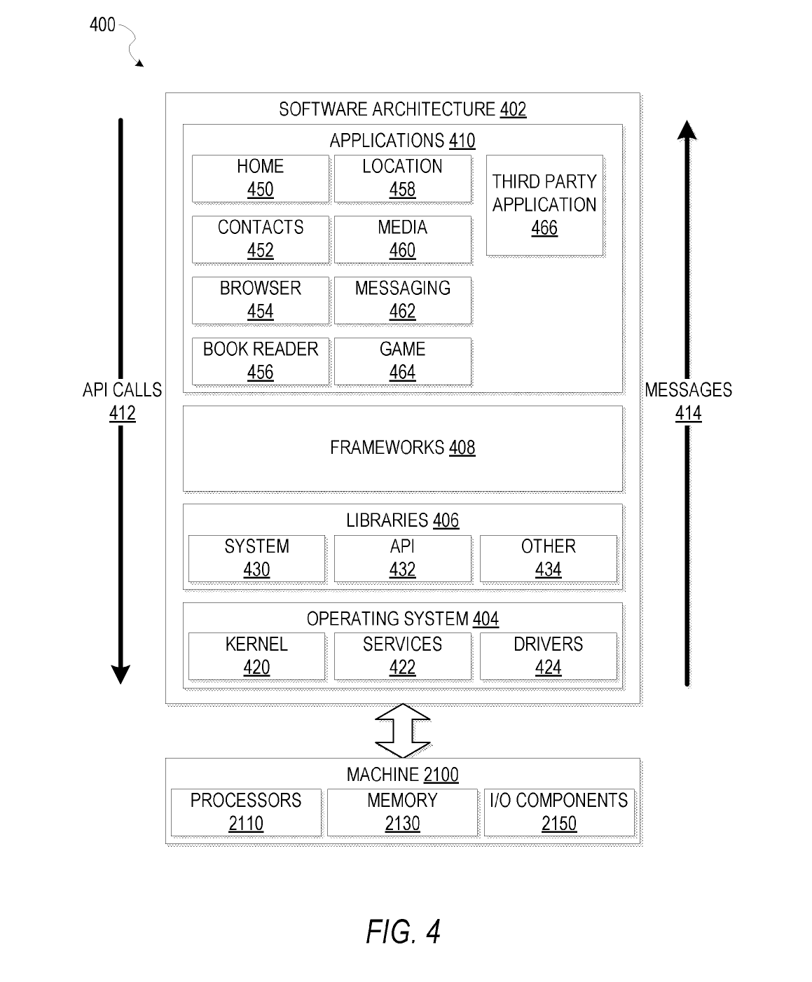

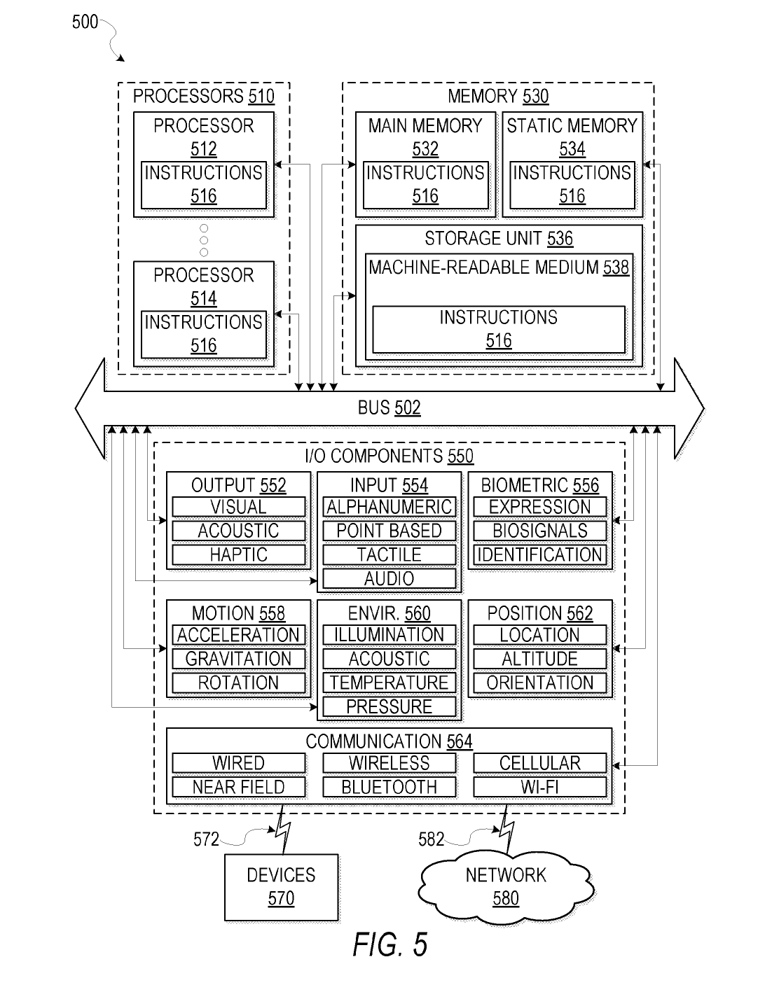

FIG. 4 is a block diagram 400 illustrating an architecture of software 402, which may be installed on any one or more of the devices described above. FIG. 4 is merely a non-limiting example ofa software architecture 402 and it will be appreciated that many other architectures may be implemented to facilitate the functionality described herein. The software 402 may be executing on hardware such as machine 500 of FIG. 5 that includes processors 510, memory 530, and I/O components 550. In the example architecture of FIG. 4, the software 402 may be conceptualized as a stack of layers where each layer may provide particular functionality. For example, the software 402 may include layers such as an operating system 404, libraries 406, frameworks 408, and applications 410. Operationally, the applications 410 may invoke application programming interface (API) calls 412 through the software stack and receive messages 414 in response to the API calls 412.

The operating system 404 may manage hardware resources and provide common services. The operating system 404 may include, for example, a kernel 420, services 422, and drivers 424. The kernel 420 may act as an abstraction layer between the hardware and the other software layers. For example, the kernel 420 may be responsible for memory management, processor management (e.g., scheduling), component management, networking, security settings, and so on. The services 422 may provide other common services for the other software layers. The drivers 424 may be responsible for controlling or interfacing with the underlying hardware. For instance, the drivers 424 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 406 may provide a low-level common infrastructure that may be utilized by the applications 410. The libraries 406 may include system 430 libraries (e.g., C standard library) that may provide functions such as memory allocation functions, string manipulation functions, mathematic functions, and the like. In addition, the libraries 406 may include API libraries 432 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 406 may also include a wide variety of other libraries 434 to provide many other APIs to the applications 410.

The frameworks 408 may provide a high-level common infrastructure that may be utilized by the applications 410. For example, the frameworks 408 may provide various graphic user interface (GUI) functions, high-level resource management, high-level location services, and so forth. The frameworks 408 may provide a broad spectrum of other APIs that may be utilized by the applications 410, some of which may be specific to a particular operating system 404 or platform.

The applications 410 include a home application 450, a contacts application 452, a browser application 454, a book reader application 456, a location application 458, a media application 460, a messaging application 462, a game application 464, and a broad assortment of other applications such as third party application 466. In a specific example, the third party application 466 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems 404. In this example, the third party application 466 may invoke the API calls 412 provided by the mobile operating system 404 to facilitate functionality described herein.

### Example Machine Architecture and Machine-Readable Medium

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 500 capable of executing the instructions 516, sequentially or otherwise, that specify actions to be taken by machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other via a bus 502. In an example embodiment, the processors 510 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 512 and processor 514 that may execute instructions 516. The term “processor” is intended to include multi-core processor that may comprise two or more independent processors (also referred to as “cores”) that may execute instructions 516 contemporaneously. Although FIG. 5 shows multiple processors 510, the machine 500 may include a single processor 510 with a single core, a single processor 510 with multiple cores (e.g., a multi-core process), multiple processors 510 with a single core, multiple processors 510 with multiples cores, or any combination thereof.

The memory 530 may include a main memory 532, a static memory 534, and a storage unit 536 accessible to the processors 510 via the bus 502. The storage unit 536 may include a machine-readable medium 538 on which is stored the instructions 516 embodying any one or more of the methodologies or functions described herein. The instructions 516 may also reside, completely or at least partially, within the main memory 532, within the static memory 534, within at least one of the processors 510 (e.g., within the processor's cache memory), or any suitable combination thereof, during execution thereof by the machine 500. Accordingly, the main memory 532, static memory 534, and the processors 510 may be considered as machine-readable media 538.

As used herein, the term “memory” refers to a machine-readable medium 538 able to store data temporarily or permanently and may be taken to include, but not be limited to, random-access memory (RAM), read-only memory (ROM), buffer memory, flash memory, and cache memory. While the machine-readable medium 538 is shown in an example embodiment to be a single medium, the term “machine-readable medium” should be taken to include a single medium or multiple media (e.g., a centralized or distributed database, or associated caches and servers) able to store instructions 516. The term “machine-readable medium” shall also be taken to include any medium, or combination of multiple media, that is capable of storing instructions (e.g., instructions 516) for execution by a machine (e.g., machine 500), such that the instructions 516, when executed by one or more processors of the machine 500 (e.g., processors 510), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 550 may include a wide variety of components to receive input, provide output, produce output, transmit information, exchange information, capture measurements, and so on. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and force of touches or touch gestures, or other tactile input components), audio input components (e.g., a microphone), and the like.

In further example embodiments, the I/O components 550 may include biometric components 556, motion components 558, environmental components 560, or position components 562 among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometer that detects ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via coupling 582 and coupling 572 respectively. For example, the communication components 564 may include a network interface component or other suitable device to interface with the network 580. In further examples, communication components 564 may include wired communication components, wireless communication components, cellular communication components, near field communication (NFC) components, Bluetooth® components (e.g., Bluetooth® Low Energy), Wi-Fi® components, and other communication components 564 to provide communication via other modalities. The devices 570 may be another machine 500 or any of a wide variety of peripheral devices (e.g., a peripheral device coupled via a Universal Serial Bus (USB)).

Moreover, the communication components 564 may detect identifiers or include components operable to detect identifiers. For example, the communication components 564 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 580 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or other type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., hypertext transfer protocol (HTTP)). Similarly, the instructions 516 may be transmitted or received using a transmission medium via the coupling 572 (e.g., a peer-to-peer coupling) to devices 570. The term “transmission medium” shall be taken to include any intangible medium that is capable of storing, encoding, or carrying instructions 516 for execution by the machine 500, and includes digital or analog communications signals or other intangible medium to facilitate communication of such software.

Furthermore, the machine-readable medium 538 is non-transitory (in other words, not having any transitory signals) in that it does not embody a propagating signal. However, labeling the machine-readable medium 538 as “non-transitory” should not be construed to mean that the medium is incapable of movement; the medium should be considered as being transportable from one physical location to another. Additionally, since the machine-readable medium 538 is tangible, the medium may be considered to be a machine-readable device.

### Language

Throughout this specification, plural instances may implement components, operations, or structures described as a single instance. Although individual operations of one or more methods are illustrated and described as separate operations, one or more of the individual operations may be performed concurrently, and the operations may not be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system to manage system resources, comprising:
at least one processor configured to perform operations for processor-implemented modules including:
a budget module configured to determine allocated resource budgets for a plurality of groups using system resources;
a budget consumption module configured to determine a group from the plurality of groups is over-consuming the allocated resource budget based on a first set of rules;
a system state module configured to determine the system is operating in a busy state based on a second set of rules; and
a capping module configured to determine whether to enforce capping on the allocated resource budget of the group based on the over-consuming of the allocated resource budget by the group and the busy state of the system.

2. The system of claim 1, wherein the capping module is further configured to enforce capping on the allocated resource budget based on a third set of rules associated with prioritized workloads for the group.

3. The system of claim 1, wherein the first set of rules is based on a daily budget of the group.

4. The system of claim 1, wherein the first set of rules is based on:
determining an hourly consumption of the group has been exceeded by a first percentage of an hourly budget; and
determining a daily consumption of the group has been exceeded by a second percentage of a daily budget.

5. The system of claim 1, wherein an hourly budget is determined by an average consumption by the group over a rolling period of time hourly, and wherein a daily budget is determined by an average consumption by the group over a rolling period of time daily.

6. The system of claim 1, wherein the second set of rules is based on determining the system is operating at a designated busy state based on exceeding a threshold value, the threshold value representing a number of active sessions or delayed sessions in a system queue.

7. The system of claim 2, wherein the third set of rules is based on:
evaluating an hourly budget at two hour increments to determine if the group has reached a first percentage of the allocated resource budget;
evaluating a daily budget to determine whether the group is over-consuming on a daily budget based on a second percentage of the allocated resource budget; and
providing information to reprioritize workloads from at least one tier lower than the highest priority tier.

8. The system of claim 2, wherein the third set of rules is based on:
determining whether the group has reached a first percentage of a granular budget; and
capping lowest priority workloads associated with a lowest priority tier.

9. The system of claim 2, wherein the third set of rules is based on
determining whether the group has reached a first percentage of an hourly budget;
capping lowest priority workloads associated with a lowest priority tier;
determining whether the group has reached a second percentage of a daily budget; and
capping at least two of the lowest priority workloads associated with two lowest priority tiers.

10. The system of claim 2, wherein the third set of rules is based on a plurality of tiers for prioritizing the workload for the group.

11. The system of claim 1, further comprising a grouping module configured to determining the group based upon an organizational structure of a business entity.

12. The system of claim 11, wherein the grouping module further comprises automatically updating a plurality of users associated with the group based on changes in the organization structure.

13. The system of claim 11, wherein the grouping module is further configured to associate batch ids for batch data processing to various groups in a plurality of groups.

14. The system of claim 11, wherein the grouping module is further configured to prioritize batch ids into one of a plurality of tiers, each of the plurality of tiers having different priority levels.

15. The system of claim 2, further comprising a rule configuration module configured to configure one or more parameters from the first set of rules, the second set of rules or the third set of rules.

16. A method for managing resources of a system, comprising:
receiving a budget for resources allocated to a group from a plurality of groups using the system;
determining whether to enforce capping on the group using the system based on an over-consumption of the budget for resources allocated to the group and the system having a designated busy state; and
enforcing capping on the budget for resources allocated to the group based on prioritized workloads associated with the group.

17. The method of claim 16, wherein determining to enforce capping further comprises:
evaluating whether an hourly budget for resources allocated to the group has been exceeded by a first percentage;
evaluating whether a daily budget for resources allocated to the group has been exceeded by a second percentage;
determining the hourly budget for resources allocated to the group and the daily budget for resources allocated to the group have been exceeded; and
determining the system has a designated busy state after determining the hourly budget for resources allocated to the group and the daily budget for resources allocated to the group has been exceeded.

18. The method of claim 16, wherein enforcing capping based on prioritized workloads associated with the group further comprises:
evaluating an hourly budget for resources allocated to the group to determine if the group has reached a first percentage of the hourly budget;
evaluating a daily budget for resources allocated to the group to determine whether the group is over-consuming on the daily budget based on a second percentage of the daily budget; and
providing information to delay processing of capped workloads, the capped workloads representing lower priority workloads based on the prioritized workloads associated with the group.

19. The method of claim 18, wherein enforcing capping based on prioritized workloads associated with the group further comprises:
receiving input from a user to adjust the first percentage or the second percentage.

20. A non-transitory machine readable medium storing instructions that, when executed by at least one processor of a machine, cause the machine to perform operations comprising:
determining a group from a plurality of groups is over-consuming an allocated resource budget based on a first set of rules;
determining a system is operating in a busy state based on a second set of rules;
determining whether to enforce capping on the allocated resource budget of the group based on over-consuming of the allocated resource budget by the group and the busy state of the system; and.
enforcing capping on the allocated resource budget based on a third set of rules associated with a plurality of tiers for prioritizing a workload for the group.
